(19) United States
(12) Patent Application Publication
(10) Pub. No.: US 2014/0090370 A1
(43) Pub. Date: Apr. 3, 2014

(54) ACTUATOR

(71) Applicants: Stefan HAGMANN, Meierskappel (CH); Robert PARTEL, Zug (CH); Fabian RISCH, Zurich (CH)

(72) Inventors: Stefan HAGMANN, Meierskappel (CH); Robert PARTEL, Zug (CH); Fabian RISCH, Zurich (CH)

(73) Assignees: INVENTAS AG, Baar (CH); SIEMENS AKTIENGESELLSCHAFT, Munchen (DE)

(21) Appl. No.: 14/039,371

(22) Filed: Sep. 27, 2013

(30) Foreign Application Priority Data
Sep. 28, 2012 (EP) 12186727

(51) Int. Cl. F03G 7/06

(52) U.S. Cl. CPC F03G 7/065
USPC 60/527

(57) ABSTRACT

An actuator having a housing, a connecting element, a shape memory element which changes shape when heated, a heating element and a heat conducting element. The shape memory element is configured in substantially elongate form and is arranged in the housing such that it displaces the connecting element when it changes shape. The heating element, when activated, heats the shape memory element. The heat conducting element is in contact with the shape memory element at least some of the time, at a contact surface which is larger than 0.1 times the total surface of the shape memory element. While in contact with the shape memory element, the heat conducting element bears at least partially displaceably against the latter and has a free surface which is not in contact with either the shape memory element or the heating element that is at least 1.6 times larger than its contact surface.

### CROSS REFERENCE TO RELATED APPLICATIONS

This application is based on and hereby claims priority to European Application No. 12186727 filed on Sep. 28, 2013, the contents of which are hereby incorporated by reference.

### BACKGROUND

Described below is an actuator with a shape memory element that displaces a connecting element when heated, which connecting element, when the actuator is for example mounted on a valve, in turn displaces the plunger of the latter.

Actuators using shape memory elements are already used, inter alia, in the fields of automotive engineering and building automation, in particular for unlocking door locks or, more recently, for closing air vents for safety reasons in the event of a fire. In these applications, such actuators must be cost effective, easy to manufacture in large numbers, reliable and durable, and specifically they must be able to generate a minimum working travel and a minimum force, a minimum number of actuation cycles or have a minimum life. Depending on the application, they must not exceed either a maximum switch-on time or a maximum switch-off time.

### SUMMARY

An actuator illustrated in FIGS. 11 and 12 of U.S. Pat. No. 4,841,730 is supposed to be able to switch on only once by an exothermic reaction, for which reason in particular no measures for cost effective, rapid and even cooling of the rotating shape memory element are shown.

A linear drive with unspecified application is already shown in DE9100339U1, which contains a heat conducting element, specifically a tubular element made of a material having good heat conducting properties. For the purpose of cooling this element, the housing has ventilation openings. For the purpose of heating this element, the tubular element is, at another location, in contact with a heating element. The tubular element encloses a helical spring made of shape memory metal arranged parallel thereto. This spring made of shape memory metal is supported laterally by an internal end face of the housing, and not by the tubular element. As a result, it cannot come into contact with the tubular element as would be necessary for optimum heat transfer. Accordingly, the spring made of shape memory metal has, along its length, a round cross section which does not fit the inside of the tubular element.

US 2001/0038082A1 describes an actuator using a shape memory element for a regulator valve, wherein mention is made of an application in industrial production, in particular in the semiconductor industry, that is to say in a very stable climate. Regulation requires at any time a precise dose of heating or cooling. For this reason, an active cooling element such as a rotating fan, a piezoelectric fan or a Peltier semiconductor is proposed. A heat conducting element is dispensed with entirely. In addition, at least one sensor and, in practical terms, a microprocessor are required. The shape memory wire which is wound around coils cannot easily be assembled in large numbers. Fans produce noise and, unless in a clean room, would promote the deposition of dust also in places which are sensitive for the mechanism.

Arcuate shape memory elements for drives with indeterminate application are suggested in the article “Actuators and drives based on Cu—Al—Ni shape memory single crystals” by A. Priadko, S. Pulnev, I. Viahhi, V. Vetrov and V. Yudin from the Institute for Robotics and Technical Cybernetics in St. Petersburg, Russia. Therein, the heating of the shape memory elements is provided by a wound resistance wire, which makes even heating possible but hinders cooling. A heat conducting element is not present.

WO 2003/069644 shows an actuator wherein a straight shape memory element is mechanically connected, over only part of its length, to a heat conducting element of electrically and thermally conductive plastic, which is difficult to produce. No measures for rapid and even cooling of the shape memory element are present.

U.S. Pat. No. 4,765,139 describes a drive also having a straight or having an arcuate shape memory element. Heating and cooling of this element is provided by elaborate thermoelectric semiconductor generators via metal wire brushes that are in contact with it over a small surface. The shape memory element is thus heated and cooled rapidly but not evenly and not cost effectively.

Actuators using shape memory elements should also be used for control systems for heating, ventilation or air conditioning, in particular in order to actuate valves for water, coolant or gas. For this purpose, actuators are needed which work in the actuation range of 2 to 3 mm and at actuation forces of approximately 100 N, wherein such values are to be interpreted merely as typical examples or as an indication of an order of magnitude. These performances must be maintained typically for 100 000 actuation cycles over 8 years.

Both switching on and switching off actuators in control systems for heating, ventilation or air conditioning should be performed within a maximum time. These maximum times are dependent on the application and are, for example for switching on and for switching off, in each case one minute. The annual power consumption for such actuators should also remain within a maximum value, approximately 30 kWh depending on the application. They must be sufficiently robust in order to withstand an overload in operation, which for example may arise suddenly as a result of a foreign body in the actuation region, or may arise over time as a result of wear. Above all, however, actuators installed in living spaces must operate almost silently.

Until now, the only suitable actuators have been ones which work by a geared electric motor, on the basis of a solenoid, or by a heatable wax-filled cylinder having a lifting piston. This last solution setup makes particularly quiet operation possible.

For a long time, so far without recognizable success, efforts have also been made to develop actuators on the basis of a shape memory element that are matched to such requirements. Shape memory elements have the advantages of wear-free and silent operation, and comparatively low component costs.

The temperature balance is a particular challenge here, for one because, during operation of a typical length, the heating element has to hold the shape memory element at a raised temperature. Thermally insulating the shape memory element would reduce energy losses, but would negatively affect the cooling thereof, meaning that the shape memory element might not return to its initial shape within the prescribed maximum switch-off time. An additional difficulty is that the actuator is exposed to alternately high ambient temperatures, at which the shape memory element is slow to return to its initial shape. At other operating times, the ambient temperature may be low, which increases the switch-on time. In particular, valve actuators in tight spaces with heating lines are sometimes exposed to high temperatures.

As an additional challenge, an actuator using a shape memory element, when used in a control system for heating, ventilation or air conditioning, as compared to traditional applications, must develop a lot of force. For the sake of simple manufacturing, and in order to avoid the need for gearing, a large single cross section of a compact shape memory element is advantageous with respect to the multiple cross section of a wound shape memory wire. However, this reduces the surface area with respect to the volume, which further increases the challenge with respect to the temperature balance.

In the same way, fatigue testing has shown that heating only one small surface of the shape memory element does not reliably provide the high force and minimum number of actuation cycles with the minimum working travel, for which reason it is desirable for the shape memory element to be heated evenly.

EP304944A2 shows valve drives in control systems for heating, ventilation or air conditioning, which have disk shaped shape memory rings. When heated, the shape memory rings each turn outward to form a frustum, wherein practically any contact with a heat conducting element arranged in the center is lost. They are optionally heated or cooled by flooding with the fluid to be controlled. It is not known whether such valve drives have ever been available on the market.

EP922892A1 describes an actuator for use in control systems for heating, ventilation or air conditioning, in order to switch a valve back and forth between two actuation points, specifically with it being possible to reverse the working direction. It uses, for example, a metal band made of a shape memory alloy, the length of which changes when it is heated. No heat conducting element is present. No such actuator is available on the market.

EP1926928A1 recently disclosed an actuator of the type described above. It is designed to switch a valve back and forth between two actuation points. A heat conducting element extends only between the metallic component, made of an alloy with imprinted shape memory, and the heating element. It is in contact with a small surface of the component on at least one longitudinal side, and there over a substantial portion of the width of the latter, but is not suited to coping with the requirements of the temperature balance. The component itself is configured to be substantially straight, because it is in an arc, which arc stretches when heated. It is oriented substantially transverse to the direction of movement of the valve plunger. Such an actuator is currently not available on the market.

It is possible to substantially improve simple mechanical actuators based on a shape memory element, and in particular to make them suitable for applications in control systems for heating, ventilation or air conditioning.

A heat conducting element having a free surface permits, within the widely varying operational conditions, an optimized balance between switch-on time, switch-off time, energy efficiency and durability, and at the same time supports the holding of the shape memory element. For cooling purposes, the free surface is at least 1.6 times larger than the surface at which the heat conducting element is in contact with the shape memory element.

### BRIEF DESCRIPTION OF THE DRAWINGS

These and other aspects and advantages will become more apparent and more readily appreciated from the following description of the exemplary embodiments, taken in conjunction with the accompanying drawings of which.

FIG. 1 is a schematic view in section of an actuator and a water valve on which the latter is mounted.

FIG. 2 is a partially schematic perspective view of the actuator of FIG. 1 and the water valve on which the latter is mounted.

FIG. 3 is a schematic perspective view of a shape memory element, a heating element and a heat conducting element of the actuator of FIG. 1.

FIG. 4 is a schematic side view of the shape memory element, an alternative heating element and an alternative heat conducting element of an actuator.

FIG. 5 is a schematic perspective view of the shape memory element, the heating element and the heat conducting element of the actuator of FIG. 4.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

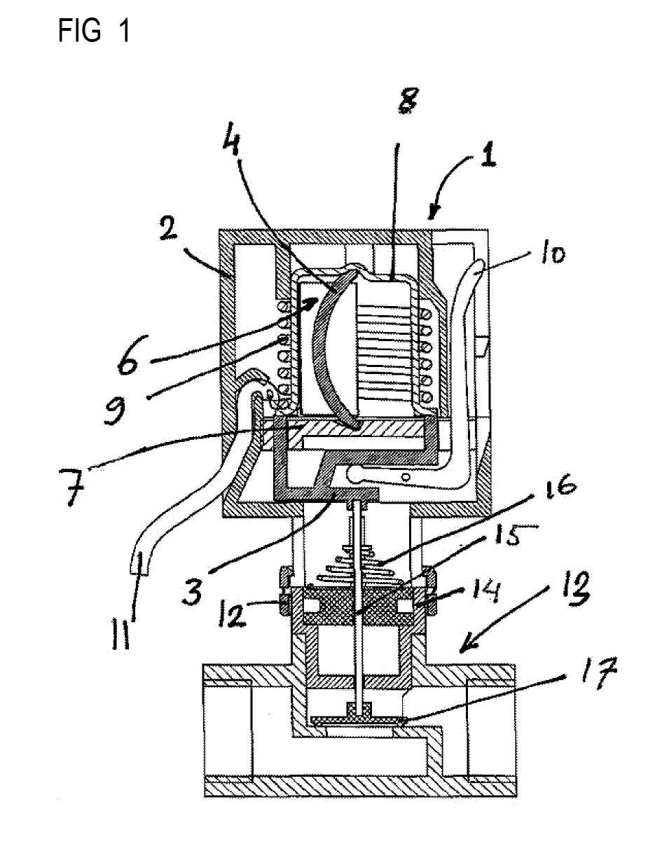

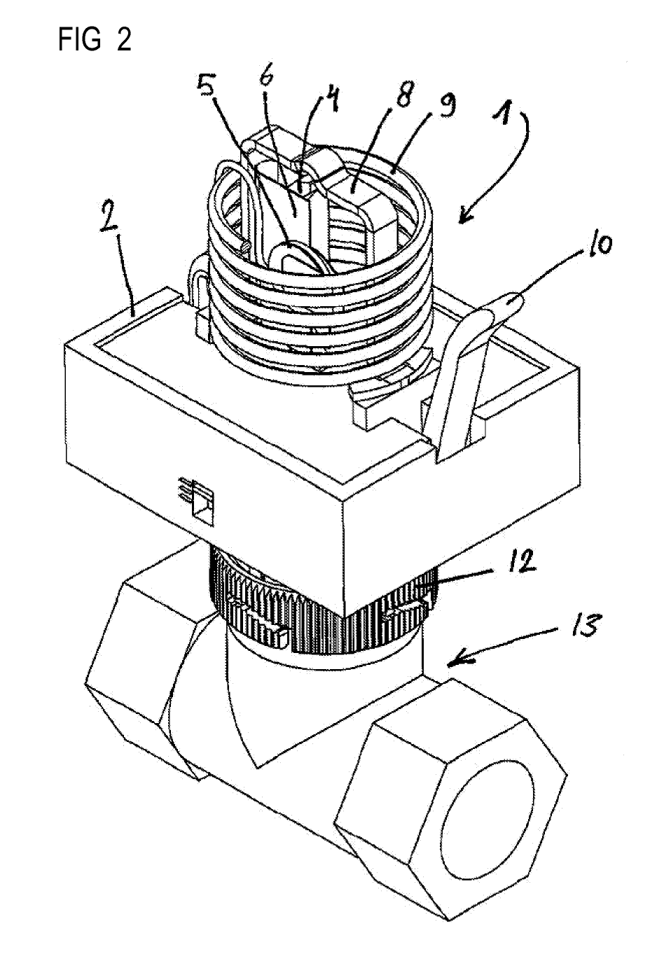

In FIGS. 1 and 2, the actuator 1 includes a housing 2, a connecting element 3, a shape memory element 4, a heating element 5 and a heat conducting element 6. In this position, the shape memory element 4 has not been switched on by being heated.

For the purpose of cost effective manufacturing, the heat conducting element 6 is made of sheet metal. There are many alloys which have sufficient heat conducting properties and can be bent to the right extent. It has been found that alloys having a weight fraction of copper of 90%, possibly with a smooth, corrosion resistant coating, are particularly suitable. In one embodiment, which is not illustrated, the heat conducting element may, thanks to highly thermally conductive coupling, additionally contain metal parts of the housing.

The housing 2 includes a stiffly connected housing part 7, in which a recess loosely receives an end of the arcuate shape memory element 4. In a similar manner, the connecting element 3 includes a yoke-shaped transmission element 8, which is held against the connecting element 3 by the pressure of a spring 9. A recess positioned centrally in the transmission element 8 loosely receives the other end of the arcuate shape memory element 4. Both recesses are configured substantially funnel shaped, in order to center the beveled ends of the shape memory element 4 when the latter changes shape.

The shape memory element 4 bears, by its longitudinal sides which extend parallel to the section plane in FIG. 1, against surfaces of the heat conducting element 6. The surface of the shape memory element at which the heat conducting element 6 is in contact with the former extends over a substantial portion of the width thereof. These heat conducting element surfaces press slightly resiliently against the shape memory element 4 and contribute to holding the latter. Thus, while it is in contact with the shape memory element 4, the heat conducting element 6 bears at least partially displaceably against the latter. Depending on the dimensions and choice of materials, it may be advantageous for a heat conducting paste to be used to lubricate the movement of the shape memory element 4 along the heat conducting surfaces, and thermally contact the shape memory element, while the latter is changing shape. In one embodiment that is not illustrated, the shape memory element may be configured in a spiral and may contact, on the outside, a heat conducting sleeve.

The shape memory element 4 is made of a known alloy, primarily of nickel and titanium, which a person skilled in the art can select, depending on the requirements, from a number of alloys which can easily be obtained commercially. When heated from approximately 70° C. to just under 100° C., the structure of the alloy changes from martensite to austenite, whereby the alloy can perform work.

In a tradeoff between force, working travel and heat balance, the shape memory element 4 may have, over at least half its length, a cross-sectional area which is larger than 0.002 times its length squared.

Electric lines for activating the heating element 5 are fed through the cable 11. The heating element 5 is a resistor having what is termed a “positive temperature coefficient” or “PTC”, which, when activated, heats up to approximately 120° C. in a self regulating manner. The heating element 5 is in contact with—and thereby heats—the heat conducting element 6, which in turn is in contact with the shape memory element 4. In one embodiment, which is not illustrated, the heating element can be an electrical supply device which, for heating purposes, generates an electrical current through the shape memory element or through a resistance wire wound around the latter.

As a consequence of being heated, the shape memory element 4 increases in length through a reduction in curvature. The shape memory element 4 is dimensioned such that, in the process, it lifts the transmission element 8 against the action of the spring 9, as a result of which the connecting element 3 is no longer depressed.

In addition, the actuator 1 can be switched on and off manually by the displacement lever 10.

The actuator 1 is mounted, by a bayonet ring 12, onto a water valve 13 having a complementary bayonet flange 14. In this case, the connecting element 3 then no longer depresses a plunger 15, for which reason a smaller spring 16 lifts it together with the valve plate 17 and allows the water to flow.

In order to switch off the actuator, the heating element 5 is deactivated, whereby the shape memory element 4 once again cools down. At approximately 80° C., its structure begins to change back to martensite, this process being complete at around 50° C. As it has an intrinsic two way effect, it returns to its initial shape without the application of any external force. This requires the shape memory element to have been “trained” according to a process corresponding to the requirements. In one embodiment, which is not illustrated, a shape memory material having an external two way effect, or having a one way effect which requires an external force, would also be possible. No training would be required for this.

In order to achieve even heating and cooling, the surface at which the heat conducting element 6 is in contact with the shape memory element 4 may be larger than 0.1 times the total surface of the shape memory element 4. Even if in one embodiment, which is not illustrated, the heating element bears directly against the shape memory element, at least during heating, the heat conducting element distributes the heat better on account of the typical properties of shape memory materials. The heating element 5 may be configured and arranged in the housing such that, while it is activated, it is in contact with the shape memory element 4 or with the heat conducting element 6 which is then in contact with the shape memory element 4, and the surface at which the heat conducting element 6 thus heats the shape memory element 4—either directly or indirectly—is larger than 0.1 times the total surface of the shape memory element 4.

Once a shape memory element has been heated up, and if the corresponding position of the actuator remains required over a longer period, the heat conducting element may, in one embodiment that is not illustrated, be brought at a distance to the shape memory element remotely, for example by switching on a smaller additional shape memory element.

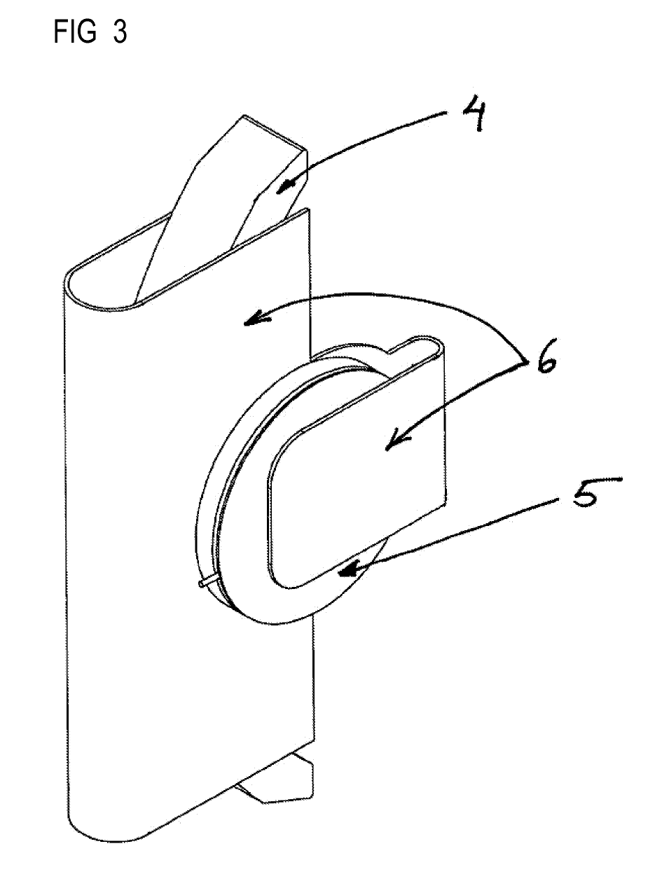

FIG. 3 shows how the heat conducting element 6 is in contact with the heating element 5, for the purpose of heat transfer and mounting, at the substantially opposing sides thereof. The heating element 5 may be clamped resiliently or received fittingly, such that no adhesive is required.

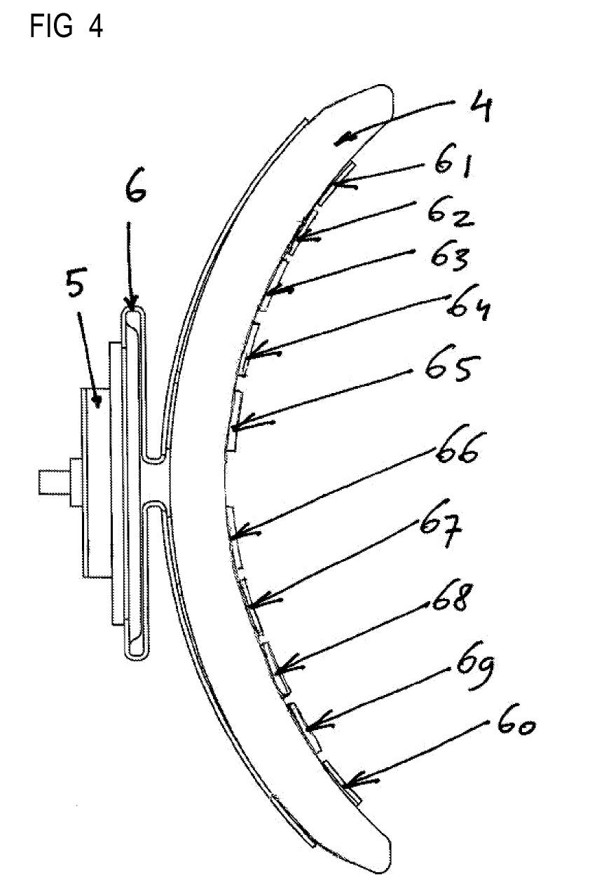

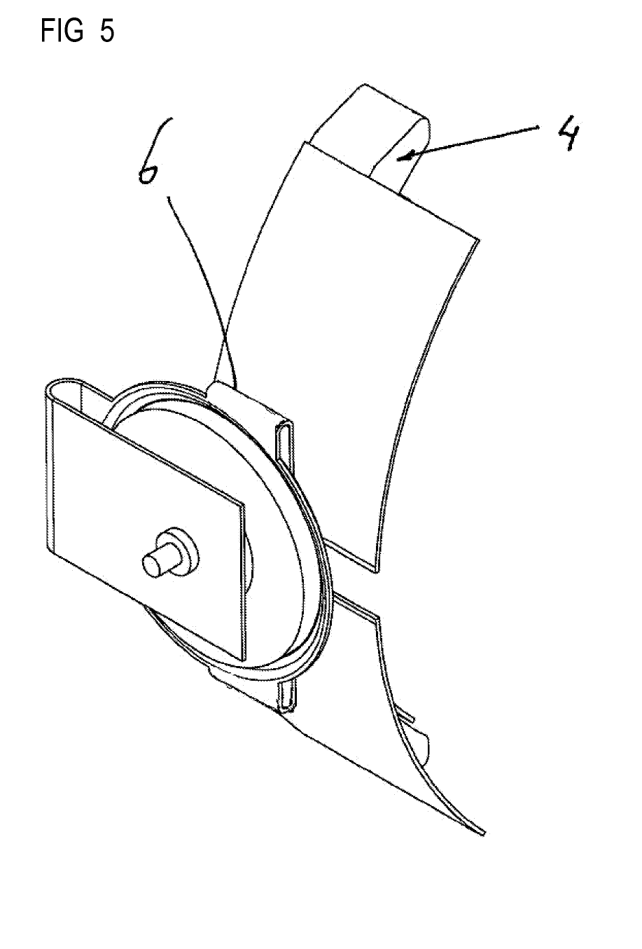

In FIGS. 4 and 5, an alternative heat conducting element 6 holds the shape memory element 4 in a clamped manner at the rear side thereof and, by its ten fingers 60 to 69, at one longitudinal side and at the front side. This results in a particularly large contact area.

The heating element 5 is decoupled from the shape memory element 4 in the sense that the heat conducting element 6 in between the two is narrowed down to have only a small cross-sectional area. The heat balance can be optimized by this partial decoupling in that the residual heat of the heating element 5 has less of a negative effect, after the latter has been deactivated, on the cooling down of the shape memory element 4, even if it slows down heating up of the shape memory element 4 at other times. For this purpose, the heat conducting element 6 may have a smallest cross-sectional which is smaller than 0.2 times the surface at which the heat conducting element 6 is in contact with the shape memory element 4.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2dl 1865 (Fed. Cir. 2004).

What is claimed is:

1. An actuator, comprising:
a housing;
a connecting element;
a shape memory element, configured in substantially elongate form and arranged in the housing, changing shape when heated to displace the connecting element;
a heating element, arranged in the housing, configured to heat the shape memory element when activated; and
a heat conducting element configured and arranged in the housing in contact with the shape memory element at least some of the time at a contact surface of the heat conducting element that is larger than 0.1 times a total surface of the shape memory element and, while in contact with the shape memory element, the heat conducting element bearing at least partially displaceably against the shape memory element, the heat conducting element having a free surface not in contact with either the shape memory element or the heating element that is at least 1.6 times larger than the contact surface at which the heat conducting element is in contact with the shape memory element.

2. The actuator as claimed in claim 1, wherein the shape memory element bears against surfaces of the heat conducting element and can move along these surfaces as the shape memory element changes shape.

3. The actuator as claimed in claim 2, wherein the heat conducting element is configured and arranged in the housing such that during cooling, the heat conducting element is in contact with the shape memory element at least some of the time.

4. The actuator as claimed in claim 3, wherein the heating element is configured and arranged in the housing such that, while activated, the heating element is in contact with at least one of the shape memory element and the heat conducting element which is in contact with the shape memory element.

5. The actuator as claimed in claim 4, wherein the heat conducting element is formed of at least sheet metal.

6. The actuator as claimed in claim 5,
wherein the shape memory element is substantially straight, and
wherein the heat conducting element is configured and arranged in the housing to be in contact with the shape memory element at substantially opposing longitudinal sides thereof at least some of the time.

7. The actuator as claimed in claim 5, wherein the shape memory element is configured substantially straight, and a length of the shape memory element changes, in particular by bending or stretching, when the shape memory element is heated.

8. The actuator as claimed in claim 5,
further comprising a transmission element,
wherein a length of the shape memory element changes when it is heated,
wherein the shape memory element is accommodated, at one end, in a first recess in a housing part and, at another end, in a second recess in the transmission element, and
wherein moving the transmission element closer to or further away from the housing part displaces the connecting element.

9. The actuator as claimed in claim 8, wherein the shape memory element has, over at least half the length thereof, a cross-sectional area larger than 0.002 times the length squared.

10. The actuator as claimed in claim 5, wherein the heat conducting element is configured and arranged in the housing such that the heat conducting element is in contact with the heating element at least at the substantially opposing longitudinal sides thereof.

11. The actuator as claimed in claim 10, wherein the heat conducting element is configured and arranged in the housing to be in contact with the heating element at least some of the time, and has, between the heating element and the shape memory element, a smallest cross-sectional area which is smaller than 0.2 times the contact surface at which the heat conducting element is in contact with the shape memory element.

12. The actuator as claimed in claim 11, wherein the heat conducting element is made of an alloy having a weight fraction of copper of at least 90%.
